(19) United States
(12) Patent Application Publication
(10) Pub. No.: US 2018/0184003 A1
(43) Pub. Date: Jun. 28, 2018

(54) MOTION MEASURING SYSTEM, MOTION MEASURING APPARATUS, AND MOTION MEASURING METHOD

(71) Applicants: Fumiya Kakoi, Tokyo (JP); Kazuhiko Kogami, Tokyo (JP)

(72) Inventors: Fumiya Kakoi, Tokyo (JP); Kazuhiko Kogami, Tokyo (JP)

(73) Assignee: Ricoh Company, Ltd., Tokyo (JP)

(21) Appl. No.: 15/841,982

(22) Filed: Dec. 14, 2017

(30) Foreign Application Priority Data
Dec. 28, 2016 (JP) 2016-255792

(51) Int. Cl. H04N 5/232; H04N 5/351; H04N 5/222; G01P 3/38; G01C 1/00; G01C 22/00

(52) U.S. Cl. CPC H04N 5/23254; H04N 5/351; G01C 22/006; G01P 3/38; G01C 1/00; H04N 5/2228

(57) ABSTRACT

A motion measuring system measures a motion of a target person. The motion measuring system includes a processor, in communication with a memory, executing a process including creating three-dimensional motion data expressing the motion with a three-dimensional point group, by measuring the motion of the target person with a depth sensor; creating motion-measurement-information data including the created three-dimensional motion data and motion information data indicating one or more kinds of information relating to one or more aspects of the motion; creating moving image data by imaging the motion of the target person; and displaying, in response to an operation by a user evaluating the aspects of the motion, the point group and the one or more kinds of information relating to the aspects of the motion based on the created motion-measurement-information data, and a moving image based on the created moving image data obtained by a single imaging operation.

### CROSS-REFERENCE TO RELATED APPLICATION

The present application claims priority under 35 U.S.C. § 119 to Japanese Patent Application No. 2016-255792, filed on Dec. 28, 2016, the contents of which are incorporated herein by reference in their entirety.

### BACKGROUND OF THE INVENTION

### 1. Field of the Invention

The present invention relates to a motion measuring system, a motion measuring apparatus, and a motion measuring method.

### 2. Description of the Related Art

For example, at nursing care sites, etc., exercise therapy such as rehabilitation and function training, etc., are carried out to promote health and recover functions of elderly people, etc. In such exercise therapy, for example, physiotherapists and caregivers evaluate walking motions, etc., of elderly people, etc., and provide guidance for improvement of walking motions, etc., thereby promoting health and recovering functions.

Furthermore, there is known a technique for measuring various kinds of human motions by using, for example, a motion sensor, etc.

Furthermore, in the rehabilitation work, there is known a technique for managing the entire history of exercise functions of a plurality of patients in units of individual patients, such as various kinds of information and exercise function data, etc., associated with rehabilitation of a plurality of patients (see, for example, Patent Document 1).

Patent Document 1: Japanese Unexamined Patent Application Publication No. 2005-352686

In exercise therapy, easy evaluation of motions can be expected by presenting, to a physiotherapist or a caregiver, etc., a moving image obtained by imaging various motions of a moving person performing the exercise therapy (for example, the an elderly person), together with various kinds of information relating to the motions (for example, information in which the motion of the moving person is displayed in three dimensions, and the stride length during a walking motion, etc.).

### SUMMARY OF THE INVENTION

An aspect of the present invention provides a motion measuring system, a motion measuring apparatus, and a motion measuring method, in which one or more of the disadvantages of the related art are reduced.

According to one aspect of the present invention, there is provided a motion measuring system for measuring a motion of a target person, the motion measuring system including a processor, in communication with a memory, executing a process including creating three-dimensional motion data expressing the motion with a three-dimensional point group, by measuring the motion of the target person with a depth sensor, the three-dimensional motion data being created based on motion range data expressing a range of the motion and measurement data created during the motion; creating motion-measurement-information data including the created three-dimensional motion data and motion information data indicating one or more kinds of information relating to one or more aspects of the motion; creating moving image data by imaging the motion of the target person; and displaying, on a display device in response to an operation by a user evaluating the one or more aspects of the motion, the three-dimensional point group and the one or more kinds of information relating to the one or more aspects of the motion based on the created motion-measurement-information data, and a moving image based on the created moving image data obtained by a single imaging operation.

### BRIEF DESCRIPTION OF THE DRAWINGS

FIG. 1 is a diagram illustrating an example of a system configuration of a motion measurement system according to an embodiment of the present invention;

FIG. 2 is a diagram for describing an example of a schematic process of the motion measurement system according to an embodiment of the present invention;

FIG. 3 is an example of a hardware block diagram of a measurement apparatus, a server apparatus, and an output apparatus according to an embodiment of the present invention;

FIG. 4 is an example of a functional block diagram of the motion measurement system according to an embodiment of the present invention;

FIG. 5 is a flowchart of an example of a process for creating background data according to an embodiment of the present invention;

FIG. 6 is a diagram for describing an example of creation of background data according to an embodiment of the present invention;

FIG. 7 is a flowchart of an example of a process from a measurement start operation to storage of moving image data and motion-measurement-information data according to an embodiment of the present invention;

FIG. 8 is a flowchart of an example of a process of creating motion-measurement-information data according to an embodiment of the present invention;

FIGS. 9A to 9E are diagrams for explaining an example of creation of walking range data according to an embodiment of the present invention;

FIG. 10 is a diagram for describing an example of creation of three-dimensional motion data according to an embodiment of the present invention;

FIG. 11 is a flowchart of an example of a process from the operation for displaying the measurement result to the display of the measurement result according to an embodiment of the present invention;

FIG. 12 is a diagram illustrating an example of a measurement result specification screen according to an embodiment of the present invention;

FIG. 13 is a diagram illustrating an example of a measurement result screen according to an embodiment of the present invention; and

FIG. 14 is a diagram illustrating another example of a measurement result screen according to an embodiment of the present invention.

### DETAILED DESCRIPTION OF THE PREFERRED EMBODIMENTS

In exercise therapy of the related art, the operation of capturing a moving image of motions of a moving person performing the exercise therapy, and the operation of measuring various kinds of information based on the moving image, have been separately performed. Therefore, in the related art, it has not been easy to evaluate the motions. Furthermore, in the related art, there has been a need to repeatedly capture moving images according to the information to be analyzed. Therefore, in the related art, the evaluation of motions has been a troublesome task.

A problem to be solved by an embodiment of the present invention is to support the evaluation of motions.

Embodiments of the present invention will be described by referring to the accompanying drawings.

### <System Configuration>

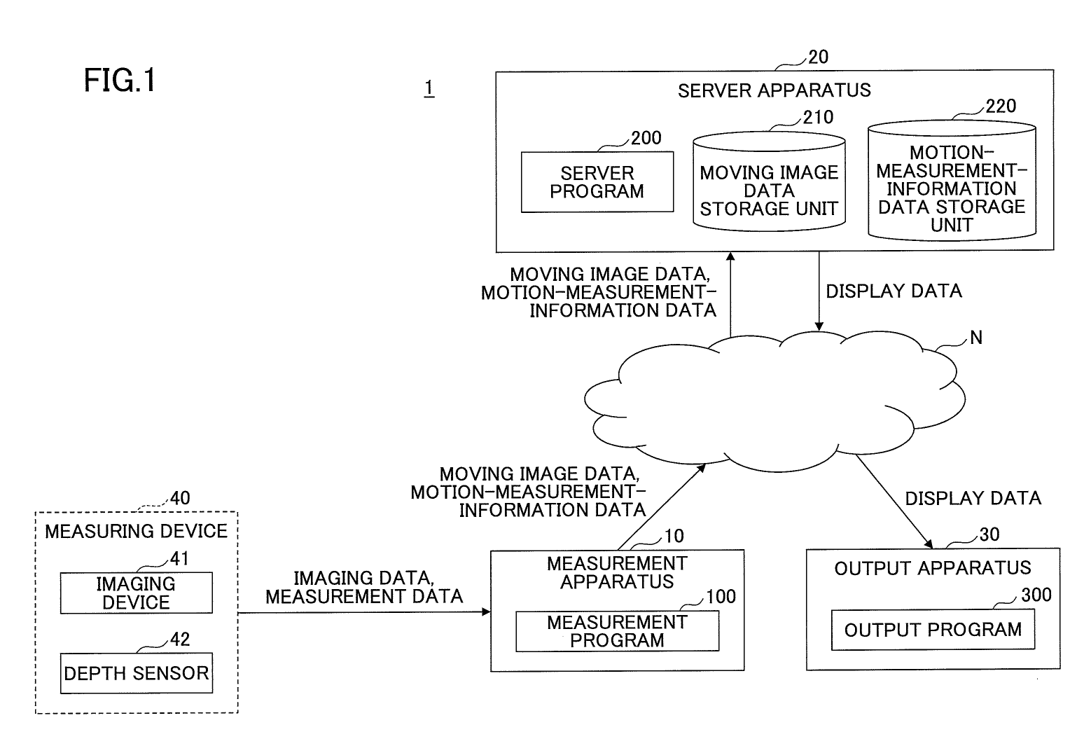

First, the system configuration of a motion measurement system 1 according to the present embodiment will be described with reference to FIG. 1. FIG. 1 is a diagram illustrating an example of a system configuration of the motion measurement system 1 according to the present embodiment.

As illustrated in FIG. 1, the motion measurement system 1 according to the present embodiment includes a measurement apparatus 10, a server apparatus 20, an output apparatus 30, and a measuring device 40. The measurement apparatus 10, the server apparatus 20, and the output apparatus 30 are communicatively connected via a wide area network N such as the Internet, for example.

The measurement apparatus 10 is an information processing apparatus such as a personal computer (PC), a smartphone, and a tablet terminal, etc. In the measurement apparatus 10, a measurement program 100 is installed.

The measurement apparatus 10 receives imaging data from the measuring device 40 by the measurement program 100, and creates moving image data from the received imaging data. Furthermore, the measurement apparatus 10 receives measurement data from the measuring device 40 by the measurement program 100, and creates motion-measurement-information data from the received measurement data. Furthermore, the measurement apparatus 10 transmits the imaging data and the motion-measurement-information data to the server apparatus 20 by the measurement program 100.

The imaging data is data created as the measuring device 40 captures images of the motions, etc., of the person to be measured (the measured person or the target person). The moving image data is data created by encoding the imaging data with a predetermined codec, etc., and then setting the encoded imaging data into a predetermined format.

Furthermore, the measurement data is data created as the measuring device 40 measures a motion, etc., of the measured person. The motion-measurement-information data includes data for displaying the motion of the measured person in three dimensions (three-dimensional motion data) and data (motion information data) indicating motion information of the measured person while moving (for example, the number of steps, the stride length, the walking speed, and the foot lifting angle, etc., i.e., one or more aspects of the motion). To display the motion of the measured person in three dimensions means to display, for example, the motion of the measured person as a movement of a point group in an XYZ space.

The server apparatus 20 is an information processing apparatus such as a PC or a workstation, for example. In the server apparatus 20, a server program 200 is installed. Furthermore, the server apparatus 20 includes a moving image data storage unit 210 and a motion-measurement-information data storage unit 220.

The server apparatus 20 receives the moving image data and the motion-measurement-information data from the measurement apparatus 10 by the server program 200. Then, the server apparatus 20 stores the received moving image data and motion-measurement-information data in the moving image data storage unit 210 and the motion-measurement-information data storage unit 220, respectively, by the server program 200.

Furthermore, in response to a request from the output apparatus 30 (a request to display the measurement result), the server apparatus 20 creates display data from the moving image data and the motion-measurement-information data stored in the moving image data storage unit 210 and the motion-measurement-information data storage unit 220, respectively, and transmits the created display data to the output apparatus 30.

Here, the display data is data for displaying the measurement result of the motion of the measured person. The measurement result includes a moving image in which the motion of the measured person is displayed, a three-dimensional display of the motion of the measured person, and motion information (for example, the stride length) during the motion of the measured person.

The output apparatus 30 is an information processing apparatus such as a PC, a smartphone, and a tablet terminal, etc. In the output apparatus 30, an output program 300 is installed.

The output apparatus 30 transmits a request to display the measurement result to the server apparatus 20 by the output program 300. Furthermore, the output apparatus 30 displays a measurement result such as the motion of the measured person based on the display data received from the server apparatus 20, by the output program 300.

Accordingly, for example, a physiotherapist or a caregiver (hereinafter referred to as “evaluator”) is able to evaluate the motion, etc., of the measured person, etc., based on the measurement result, and provide guidance for improvement, etc., based on the evaluation. Note that the evaluation is, for example, a determination of the necessity of improvement of the motion, the necessity of improvement of the posture, etc., and the necessity of improvement of the lifestyle, etc., based on the measurement result of the motion (for example, a walking motion, etc.) of the measured person.

The measuring device 40 is a depth camera, etc., including an imaging device 41 that captures an image of the motion of the measured person within an imaging range, and a depth sensor 42 that measures the depth within the measurement range. In the measuring device 40, the imaging device 41 captures an image of the motion of the measured person within the imaging range to create imaging data. Furthermore, the measuring device 40 measures the depth within the measurement range by the depth sensor 42, and creates measurement data. In the following description, it is assumed that the imaging range of the imaging device 41 and the measurement range of the depth sensor 42 are the same range. However, the imaging range of the imaging device 41 and the measurement range of the depth sensor 42 may be different.

Although the measuring device 40 according to the present embodiment is described as being a depth camera including the imaging device 41 and the depth sensor 42, the present invention is not limited as such; for example, the imaging device 41 and the depth sensor 42 may be separate bodies.

In the following description, it is assumed that the motion of the measured person is a walking motion, as an example. However, the present embodiment is similarly applicable to various kinds of motions other than a walking motion (for example, a rushing motion, standing up from and sitting down on a chair, standing on one foot, or a combined motion that is a combination of one or more of these motions, etc.).

### <Description of Schematic Process>

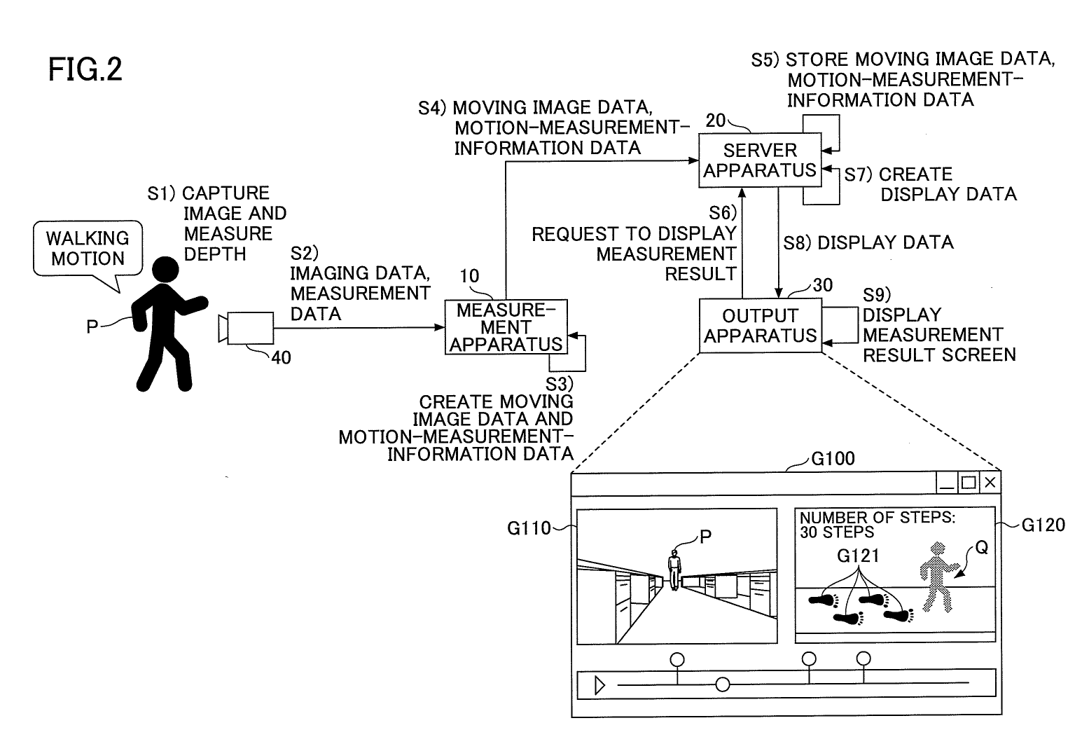

Next, a schematic process of the motion measurement system 1 according to the present embodiment will be described with reference to FIG. 2. FIG. 2 is a diagram for describing an example of a schematic process of the motion measurement system 1.

First, the measuring device 40 captures an image of a measured person P who is walking, and measures the depth within the measurement range, to create imaging data and measurement data (step S1). Next, the measuring device 40 transmits the created imaging data and measurement data to the measurement apparatus 10 (step S2).

Upon receiving the imaging data and the measurement data, the measurement apparatus 10 creates moving image data and motion-measurement-information data from the imaging data and measurement data, respectively (step S3).

That is, the measurement apparatus 10 creates moving image data by encoding the received imaging data with a predetermined codec, etc., and then setting the encoded imaging data into a predetermined format. Furthermore, the measurement apparatus 10 creates three-dimensional motion data and motion information data from the received measurement data, and creates motion-measurement-information data including the three-dimensional motion data and the motion information data.

Next, the measurement apparatus 10 transmits the created moving image data and the motion-measurement-information data to the server apparatus (step S4).

The server apparatus 20 stores the received moving image data in the moving image data storage unit 210. Furthermore, the server apparatus 20 stores the received motion-measurement-information data in the motion-measurement-information data storage unit 220. Accordingly, the server apparatus 20 stores the moving image data and the motion-measurement-information data created by imaging and measuring the motion of the measured person P (step S5).

Here, for example, when the evaluator evaluates the motion of the measured person P, the evaluator performs an operation to display the measurement result by using the output apparatus 30. In response to the display operation, the output apparatus 30 transmits a request to display the measurement result to the server apparatus 20 (step S6).

Upon receiving the measurement result display request, the server apparatus 20 creates display data from the moving image data and the motion-measurement-information data corresponding to the display request (step S7). Next, the server apparatus 20 transmits the created display data to the output apparatus 30 (step S8).

Upon receiving the display data, the output apparatus 30 displays a measurement result screen G100 based on the received display data (step S9). The measurement result screen G100 includes a moving image display field G110 for displaying a moving image obtained by capturing the motion of the measured person P, and a three-dimensional display field G120 for displaying a point group Q expressing the motion of the measured person P displayed in the moving image display field G110 as a three-dimensional point group. Here, since the point group Q displayed in the three-dimensional display field G120 is an assembly of points in the XYZ space, the point group Q can be displayed from various directions according to the operation of the evaluator, for example. Therefore, by confirming the motion of the point group Q from various directions, the evaluator can confirm the motion of the measured person P from various directions, for example.

Furthermore, in the three-dimensional display field G120, footprints G121 created during the walking motion of the measured person P, are displayed. Thus, for example, the evaluator can confirm the stride length of the measured person P during the walking motion.

As described above, the evaluator can provide guidance for improvement in the motion and the posture, etc., of the measured person P by referring to the measurement result screen G100. Similarly, the measured person P can improve his/her motion and posture, etc., by referring to the measurement result screen G100.

### <Hardware Configuration>

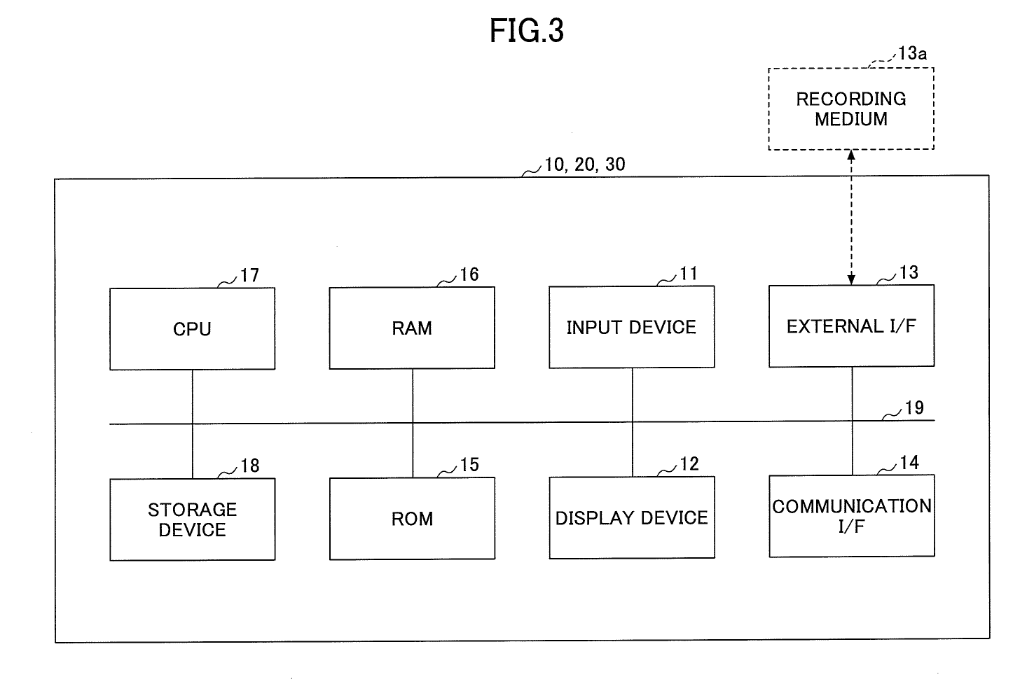

Next, a hardware configuration of the measurement apparatus 10, the server apparatus 20, and the output apparatus 30 according to the present embodiment will be described with reference to FIG. 3. FIG. 3 is an example of a hardware block diagram of the measurement apparatus 10, the server apparatus 20, and the output apparatus 30 according to the present embodiment. Since the measurement apparatus 10, the server apparatus 20, and the output apparatus 30 have substantially the same hardware configuration, the hardware configuration of the measurement apparatus 10 will be mainly described below.

As illustrated in FIG. 3, the measurement apparatus 10 according to the present embodiment includes an input device 11, a display device 12, an external interface (I/F) 13, and a communication I/F 14. Furthermore, the measurement apparatus 10 according to the present embodiment includes a Read-Only Memory (ROM) 15, a Random Access Memory (RAM) 16, a Central Processing Unit (CPU) 17, and a storage device 18. These hardware elements are connected by a bus 19.

The input device 11 includes a keyboard, a mouse, and a touch panel, etc., and is used by a user to input various operations. The display device 12 includes a display, etc., and displays processing results obtained by the measurement apparatus 10. Note that the server apparatus 20 may be configured to use at least one of the input device 11 and the display device 12 by connecting the device to the bus 19, according to need.

The external I/F 13 is an interface with an external device. The external device includes a recording medium 13a, etc. Accordingly, the measurement apparatus 10 can read and write data in the recording medium 13a, etc., via the external I/F 13. The recording medium 13a includes, for example, a flexible disk, a compact disc (CD), a digital versatile disc (DVD), a Secure Digital (SD) memory card, and a universal serial bus (USB) memory, etc.

The communication I/F 14 is an interface for connecting the measurement apparatus 10 the network N. Accordingly, the measurement apparatus 10 can communicate with another apparatus (the server apparatus 20, etc.) via the communication I/F 14.

The storage device 18 is a nonvolatile memory such as a Hard Disk Drive (HDD) or Solid State Drive a (SSD), for example, and stores programs and data. Programs and data stored in the storage device 18 include an Operating System (OS) that is basic software for controlling the entire measurement apparatus 10, application programs that provide various functions on the OS, and the measurement program 100, etc. In the storage device 18 of the server apparatus 20, the server program 200 is stored. Similarly, in the storage device 18 of the output apparatus 30, the output program 300 is stored.

The storage device 18 manages stored programs and data by a predetermined file system and/or a database (DB).

The ROM 15 is a nonvolatile semiconductor memory capable of holding programs and data even after the power is turned off. The ROM 15 stores programs and data such as Basic Input/Output System (BIOS) executed when the measurement apparatus 10 is activated, OS settings, and network settings, etc. The RAM 16 is a volatile semiconductor memory that temporarily holds programs and data.

The CPU 17 is an arithmetic device that implements the control and functions of the entire measurement apparatus 10 by loading programs and data from the ROM 15, and the storage device 18, etc., into the RAM 16, and executing processes.

The measurement apparatus 10, the server apparatus 20, and the output apparatus 30 according to the present embodiment have the hardware configuration illustrated in FIG. 3, so that various kinds of processing as described later can be implemented.

### <Functional Configuration>

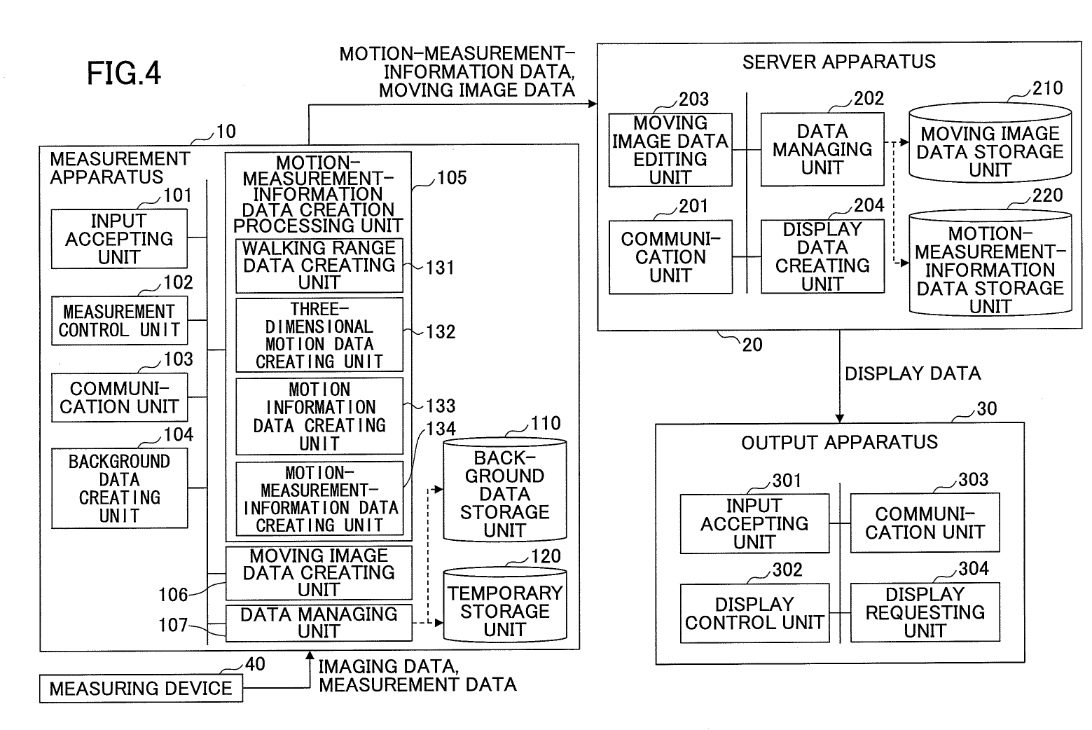

Next, the functional configuration of the motion measurement system 1 according to the present embodiment will be described with reference to FIG. 4. FIG. 4 is an Example of a Functional Block Diagram of the motion measurement system 1 according to the present embodiment.

### «Measurement Apparatus 10»

As illustrated in FIG. 4, the measurement apparatus 10 according to the present embodiment includes an input accepting unit 101, a measurement control unit 102, a communication unit 103, a background data creating unit 104, a motion-measurement-information data creation processing unit 105, a moving image data creating unit 106, and a data managing unit 107. Each of these functional units is implemented by processes that the measurement program 100 installed in the measurement apparatus 10 causes the CPU 17 to execute.

Furthermore, the measurement apparatus 10 according to the present embodiment includes a background data storage unit 110 and a temporary storage unit 120. These storage units can be implemented by using the storage device 18, for example.

The input accepting unit 101 accepts inputs of various operations by a user (for example, an evaluator). That is, the input accepting unit 101 accepts inputs such as a measurement start operation and a measurement end operation to start and end the measurement of the motion of the measured person. Furthermore, the input accepting unit 101 accepts input of an operation to create background data described later, before the measured person starts a motion (before the measured person enters the imaging range and the measuring range of the measuring device 40).

The measurement control unit 102 controls the start of imaging and the end of imaging by the measuring device 40, and the start of measurement and the end of measurement by the measuring device 40, according to operations by the user. That is, the measurement control unit 102 controls the start of imaging and the start of measurement by the measuring device 40 according to a measurement start operation. Furthermore, the measurement control unit 102 controls the end of imaging and the end of measurement by the measuring device 40 according to a measurement end operation. Furthermore, the measurement control unit 102 controls the start and the end of measurement by the measuring device 40 according to a background data creation operation.

The communication unit 103 communicates various data with the server apparatus 20 and the measuring device 40. That is, the communication unit 103 receives the imaging data and the measurement data from the measuring device 40. Furthermore, the communication unit 103 transmits the moving image data created by the moving image data creating unit 106 and the motion-measurement-information data created by the motion-measurement-information data creation processing unit 105, to the server apparatus 20.

The background data creating unit 104 creates background data from the measurement data received by the communication unit 103 before the measured person starts the motion (before the measured person enters the imaging range and the measurement range of the measuring device 40). Here, the background data means data created by measuring the depth of the place where the measured person performs the motion (that is, the depth of the place to be the background during the motion of the measured person), and smoothing the value of the measured depth (depth information).

The motion-measurement-information data creation processing unit 105 creates motion-measurement-information data including three-dimensional motion data and motion information data. Here, the motion-measurement-information data creation processing unit 105 includes a walking range data creating unit 131, a three-dimensional motion data creating unit 132, a motion information data creating unit 133, and a motion-measurement-information data creating unit 134.

The walking range data creating unit 131 creates walking range data (motion range data) from the background data created by the background data creating unit 104. The walking range data is data created by identifying the floor (walking lane) on which the measured person performs the walking motion, from the background data, and cutting out (trimming) a predetermined range including the identified walking lane, from the background data.

Based on the walking range data created by the walking range data creating unit 131 and the measurement data during the motion of the measured person, the three-dimensional motion data creating unit 132 creates three-dimensional motion data expressing the motion of the measured person with a three-dimensional point group.

The motion information data creating unit 133 creates motion information data indicating motion information (for example, the number of steps, the stride length, the walking speed, and the foot lifting angle, etc.) of the measured person based on three-dimensional motion data and the walking range data, etc.

The motion-measurement-information data creating unit 134 creates motion-measurement-information data including the three-dimensional motion data created by the three-dimensional motion data creating unit 132 and the motion information data created by the motion information data creating unit 133.

The moving image data creating unit 106 creates moving image data from imaging data. That is, the moving image data creating unit 106 creates moving image data by coding the imaging data with a predetermined codec, etc., and then setting the encoded imaging data into a predetermined format.

The data managing unit 107 manages the background data storage unit 110 and the temporary storage unit 120. That is, the data managing unit 107 stores the background data created by the background data creating unit 104 in the background data storage unit 110. Furthermore, the data managing unit 107 stores the imaging data and the measurement data received by the communication unit 103, in the temporary storage unit 120.

The background data storage unit 110 stores the background data created by the background data creating unit 104. The temporary storage unit 120 stores the imaging data and the measurement data received by the communication unit 103 during the motion of the measured person.

«Server Apparatus 20»

As illustrated in FIG. 4, the server apparatus 20 according to the present embodiment includes a communication unit 201, a data managing unit 202, a moving image data editing unit 203, and a display data creating unit 204. Each of these functional units is implemented by processes that the server program 200 installed in the server apparatus 20 causes the CPU 17 to execute.

Furthermore, the server apparatus 20 according to the present embodiment includes a moving image data storage unit 210 and a motion-measurement-information data storage unit 220. These storage units can be implemented by using the storage device 18, for example. Note that at least one storage unit among these storage units may be implemented by using a storage device, etc., connected to the server apparatus 20 via the network N, etc.

The communication unit 201 communicates various data with the measurement apparatus 10 and the output apparatus 30. That is, the communication unit 201 receives moving image data and motion-measurement-information data, etc., from the measurement apparatus 10. Furthermore, the communication unit 201 receives a request (request to display the measurement result) from the output apparatus 30. Furthermore, the communication unit 201 transmits the display data created by the display data creating unit 204, to the output apparatus 30. Note that the request to display the measurement result includes, for example, the date of measuring the measured person, identification information (measured person ID) for identifying the measured person, and a condition of a pin to be added to the moving image, etc. By adding a pin to the moving image, the evaluator, etc., can reproduce the moving image from the position indicated by the pin (that is, the replay time of the moving image indicated by the pin).

The data managing unit 202 manages the moving image data storage unit 210 and the motion-measurement-information data storage unit 220. That is, the data managing unit 202 stores the moving image data received by the communication unit 201, in the moving image data storage unit 210. Similarly, the data managing unit 202 stores the motion-measurement-information data received by the communication unit 201, in the motion-measurement-information data storage unit 220.

Furthermore, the data managing unit 202 acquires moving image data from the moving image data storage unit 210. Similarly, the data managing unit 202 acquires motion-measurement-information data from the motion-measurement-information data storage unit 220.

The moving image data editing unit 203 calculates the position of the pin to be added to the moving image data acquired by the data managing unit 202 according to the pin condition included in the request to display the measurement result. Then, the moving image data editing unit 203 edits the moving image data by adding the pin to the moving image data at the calculated position.

The display data creating unit 204 creates display data based on the moving image data edited by the moving image data editing unit 203 and the motion-measurement-information data acquired by the data managing unit 202.

The moving image data storage unit 210 stores the moving image data received by the communication unit 201. The motion-measurement-information data storage unit 220 stores the motion-measurement-information data received by the communication unit 201.

«Output Apparatus 30»

As illustrated in FIG. 4, the output apparatus 30 according to the present embodiment includes an input accepting unit 301, a display control unit 302, a communication unit 303, and a display requesting unit 304. Each of these functional units is implemented by processes that the output program 300 installed in the output apparatus 30 causes the CPU 17 to execute.

The input accepting unit 301 accepts inputs of various operations by a user (for example, an evaluator and a measured person, etc.). That is, the input accepting unit 301 accepts an input of an operation (measurement result display operation) for displaying the measurement result.

The display control unit 302 displays various screens. That is, based on the display data received by the communication unit 303, the display control unit 302 displays a measurement result screen indicating the measurement result of the motion of the measured person.

The communication unit 303 communicates various data with the server apparatus 20. That is, the communication unit 303 transmits a request to display the measurement result created by the display requesting unit 304, to the server apparatus 20. Furthermore, the communication unit 303 receives the display data from the server apparatus 20.

Upon accepting input of an operation to display the measurement result by the input accepting unit 301, the display requesting unit 304 creates a request to display the measurement result.

### <Details of Process>

Next, the process of the motion measurement system 1 according to the present embodiment will be described in detail.

«Process for Creating Background Data»

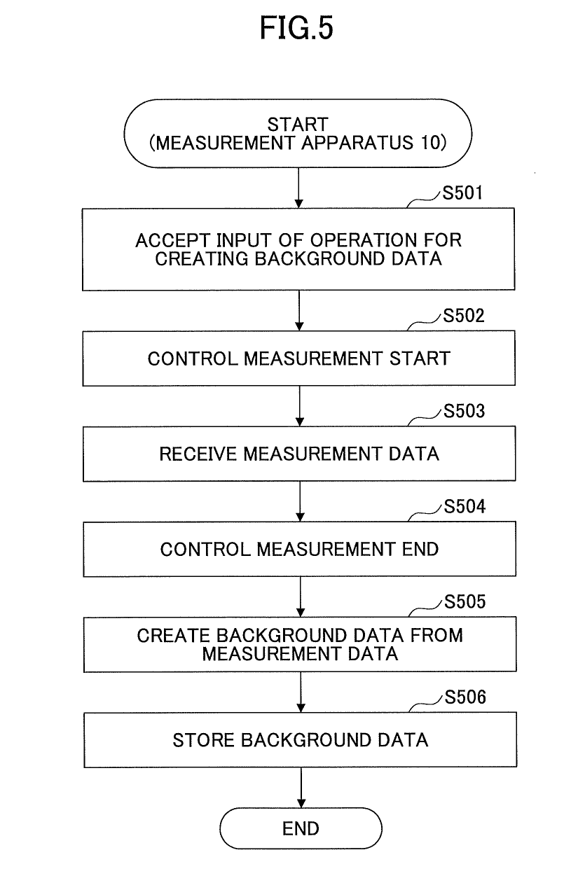

First, with reference to FIG. 5, a description will be given of a process of creating background data before a measured person starts a motion. FIG. 5 is a flowchart of an example of a process for creating background data.

First, the input accepting unit 101 of the measurement apparatus 10 accepts an input of an operation to create background data (step S501). The operation to create background data may be performed by either the evaluator or the measured person, or may be performed by a third party different from the evaluator and the measured person.

Upon accepting the input of the background data creation operation by the input accepting unit 101, the measurement control unit 102 of the measurement apparatus 10 controls the start of measurement by the measuring device 40 (step S502). Accordingly, the measuring device 40 starts the measurement of the depth within the measurement range (that is, within the imaging range of the imaging device 41) by the depth sensor 42, and creates measurement data for each inverse number of the frame rate.

Next, the communication unit 103 of the measurement apparatus 10 receives the measurement data created by the measuring device 40 (step S503).

The measurement control unit 102 of the measurement apparatus 10 controls the end of measurement by the measuring device 40 (step S504). Accordingly, the measuring device 40 ends the depth measurement by the depth sensor 42. The measurement control unit 102 may control the end of measurement by the measuring device 40, for example, when a predetermined time has elapsed since the measurement has started. Furthermore, the measurement control unit 102 may control the end of measurement by the measuring device 40 in response to a measurement end operation by the user.

Next, the background data creating unit 104 of the measurement apparatus 10 creates background data from the measurement data received by the communication unit 103 (step S505).

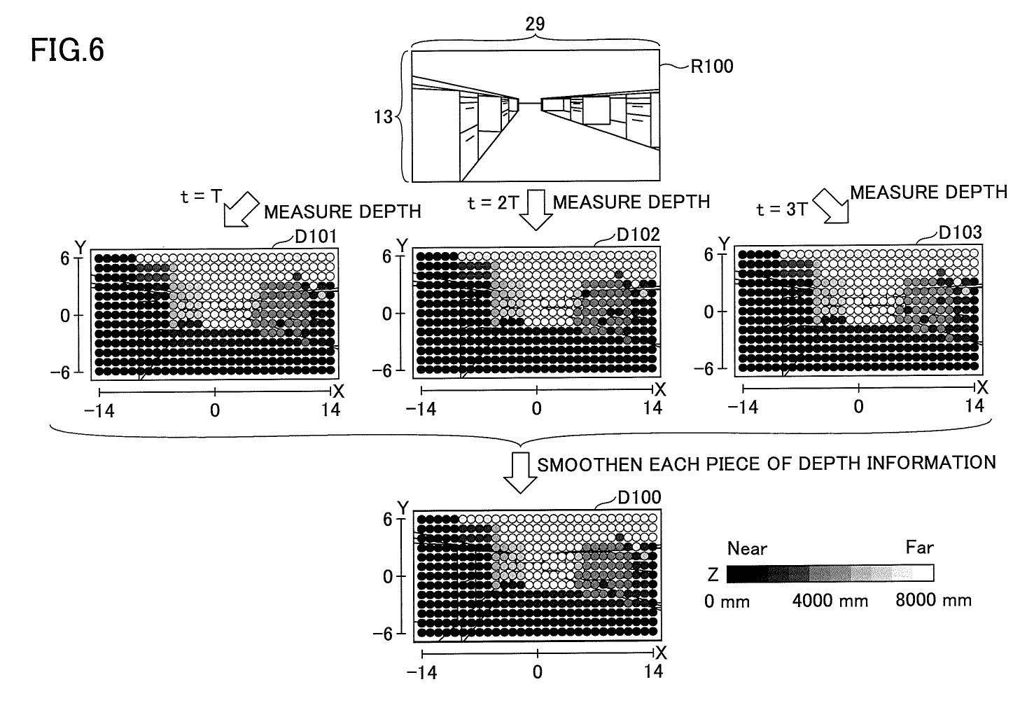

Here, an example of creating background data will be described with reference to FIG. 6. FIG. 6 is a diagram for describing an example of creation of background data.

In the example illustrated in FIG. 6, the depth sensor 42 having a resolution of 29×13, a depth measuring range of 0 mm to 8000 mm, and a frame rate (FPS: Frames Per Second) of 1/T, measures the depth of a measurement range R100 at measurement times t=T, 2T, 3T. In this case, in step S503 above, the communication unit 103 of the measurement apparatus 10 receives measurement data D101 measured at the measurement time t=T, measurement data D102 measured at the measurement time t=2T, and measurement data D103 measured at the measurement time t=3T.

By setting the center of the measurement range R100 as the origin, and assuming that the vertical direction is the X axis, the horizontal direction is the Y axis, and the measured depth value (depth information) is along the Z axis, the measurement data items D101 to D103 can be expressed as (X, Y, Z), (−14≤X≤14, −6≤Y≤6, 0≤Z≤8000).

Therefore, the background data creating unit 104 creates background data D100 by smoothing the depth information (Z) for each of X and Y of each of the measurement data items D101 to D103.

That is, for example, depth information of each measurement data item D101 to D103 at X=N (−14≤N≤14) and Y=M (−6≤M≤6) is defined as Z₁ (N, M), Z₂ (N, M), and Z₃ (N, M), respectively. In this case, the background data creating unit 104 sets the average value of Z₁ (N, M), Z₂ (N, M), and Z₃ (N, M) as depth information Z (N, M) of the background data D100 at X=N and Y=M.

Note that the background data creating unit 104 may calculate the average value upon excluding the depth information whose difference with other depth information is greater than or equal to a predetermined threshold among the depth information items Z₁ (N, M), Z₂(N, M), Z₃(N, M) (that is, the depth information having a large deviation from other depth information).

Referring back to FIG. 5, after step S505, the data managing unit 107 of the measurement apparatus 10 stores the background data created by the background data creating unit 104, in the background data storage unit 110 (step S506).

Accordingly, background data indicating the depth of the place to perform the motion is created and stored in the background data storage unit 110, before the measured person starts the motion.

«Process from Measurement Start Operation to Storage of Moving Image and Motion-Measurement-Information Data»

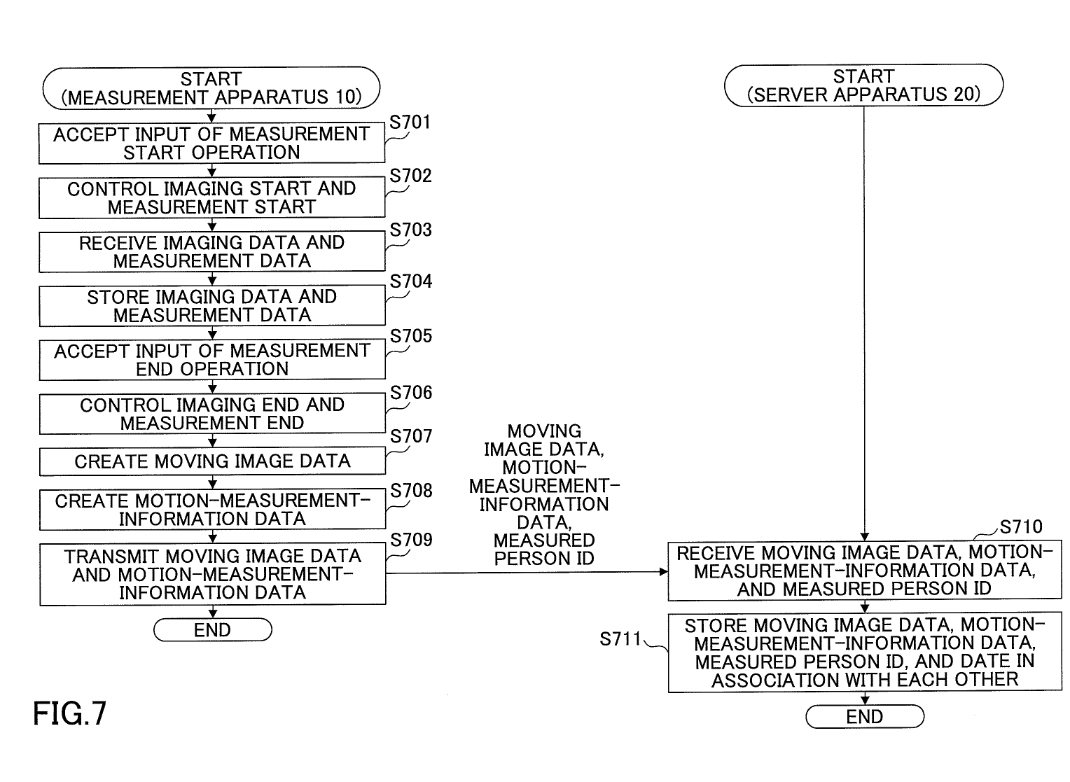

Next, with reference to FIG. 7, a description will be given of a process of measuring the motion of a measured person and storing moving image data and motion-measurement-information data in the server apparatus 20. FIG. 7 is a flowchart of an example of a process from a measurement start operation to storage of moving image data and motion-measurement-information data.

First, the input accepting unit 101 of the measurement apparatus 10 accepts input of a measurement start operation for starting the measurement of the motion of the measured person (step S701). In the measurement start operation, the measured person ID that identifies the measured person is specified. The measurement start operation may be performed by either by the evaluator or the measured person, or may be performed by a third party different from the evaluator and the measured person.

Upon accepting the input of the measurement start operation by the input accepting unit 101, the measurement control unit 102 of the measurement apparatus 10 controls the start of imaging and the start of measurement by the measuring device 40 (step S702). Accordingly, in the measuring device 40, the imaging device 41 starts imaging within the imaging range, the depth sensor 42 starts measuring the depth within the measurement range, and the measuring device 40 creates imaging data and measurement data for each inverse number of the frame rate. In the following description, it is assumed that the frame rate of the imaging device 41 is the same as the frame rate of the depth sensor 42; however, these frame rates may be different.

Next, the communication unit 103 of the measurement apparatus 10 receives the imaging data and measurement data created by the measuring device (step S703).

Next, the data managing unit 107 of the measurement apparatus 10 stores the imaging data and the measurement data received by the communication unit 103, in the temporary storage unit 120 (step S704). Accordingly, while the measured person is performing the motion, the imaging data and the measurement data created by the measuring device 40 are stored in the temporary storage unit 120.

Here, it is assumed that the user of the measurement apparatus 10 has performed a measurement end operation for ending the measurement of the motion of the measured person. Then, the input accepting unit 101 of the measurement apparatus 10 accepts input of a measurement end operation (step S705).

Upon accepting the input of the measurement end operation by the input accepting unit 101, the measurement control unit 102 of the measurement apparatus 10 controls the end of imaging and the end of measurement by the measuring device 40 (step S706). Accordingly, the measuring device 40 ends the imaging by the imaging device 41 and ends the depth measurement by the depth sensor 42.

Next, the moving image data creating unit 106 of the measurement apparatus 10 creates moving image data from the imaging data stored in the temporary storage unit 120 (step S707). That is, first, the moving image data creating unit 106 acquires the imaging data from the temporary storage unit 120 by the data managing unit 107. Then, the moving image data creating unit 106 creates moving image data by encoding the acquired imaging data with a predetermined codec, etc., and then setting the encoded imaging data into a predetermined format. After the moving image data is created by the moving image data creating unit 106, the data managing unit 107 may delete the imaging data stored in the temporary storage unit 120.

Next, the motion-measurement-information data creation processing unit 105 of the measurement apparatus 10 creates motion-measurement-information data including three-dimensional motion data and motion information data, based on the background data stored in the background data storage unit 110 and the measurement data stored in the temporary storage unit 120 (step S708). Details of the process of creating the motion-measurement-information data will be described later. Note that after the motion-measurement-information data is created by the motion-measurement-information data creation processing unit 105, the data managing unit 107 may delete the measurement data stored in the temporary storage unit 120.

Next, the communication unit 103 of the measurement apparatus 10 transmits the moving image data created by the moving image data creating unit 106, the motion-measurement-information data created by the motion-measurement-information data creation processing unit 105, and the measured person ID specified in the measurement start operation, to the server apparatus 20 (step S709).

The communication unit 201 of the server apparatus 20 receives the moving image data, the motion-measurement-information data, and the measured person ID from the measurement apparatus 10 (step S710).

Next, the data managing unit 202 of the server apparatus 20 associates the moving image data and the measured person ID received by the communication unit 201 with the present date (the date when the motion of the measured person has been measured), and stores the data in the moving image data storage unit 210. Furthermore, the data managing unit 202 associates the motion-measurement-information data and the measured person ID received by the communication unit 201 with the present date, and stores the data in the motion-measurement-information data storage unit 220 (step S711).

Accordingly, the moving image data and the motion-measurement-information data created by imaging and measuring the motion of the measured person, are stored in the moving image data storage unit 210 and the motion-measurement-information data storage unit 220 in association with the measured person ID and the date.

«Process for Creating Motion-Measurement-Information Data»

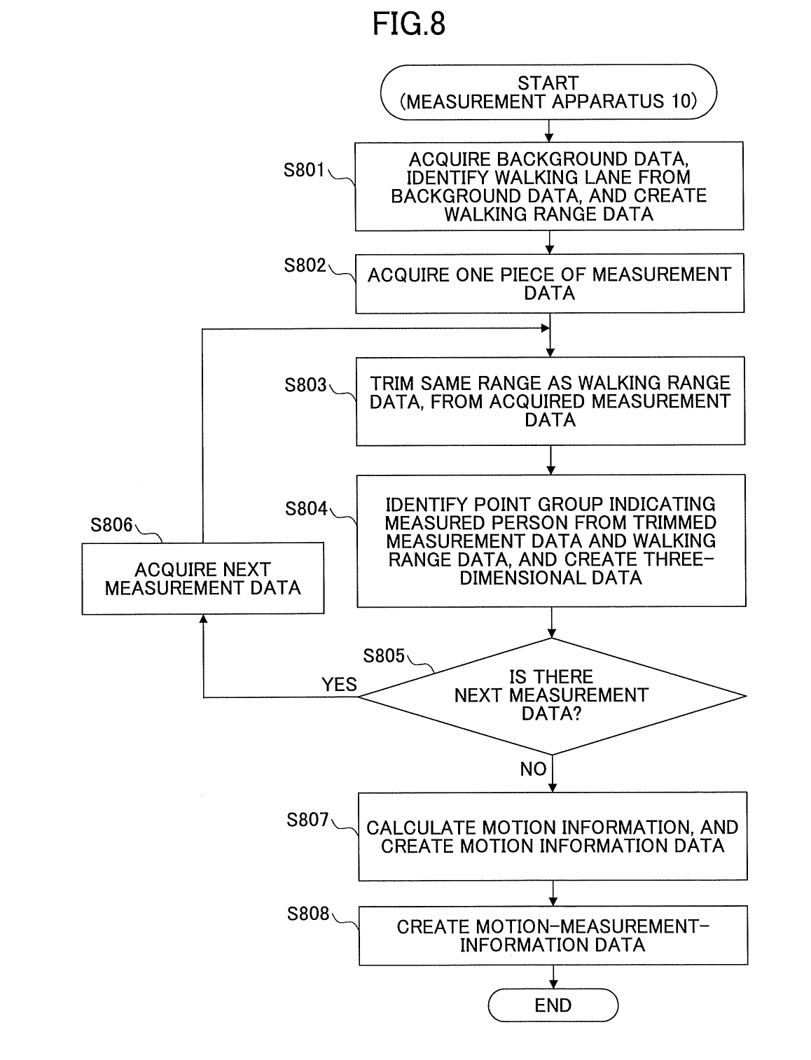

Next, the details of the process of creating the motion-measurement-information data in step S708 of FIG. 7 will be described with reference to FIG. 8. FIG. 8 is a flowchart of an example of a process of creating motion-measurement-information data.

First, the data managing unit 107 acquires background data from the background data storage unit 110. Then, the walking range data creating unit 131 identifies a walking lane from the background data acquired by the data managing unit 107, and cuts out a predetermined range including the identified walking lane from the background data, thereby creating walking range data (step S801).

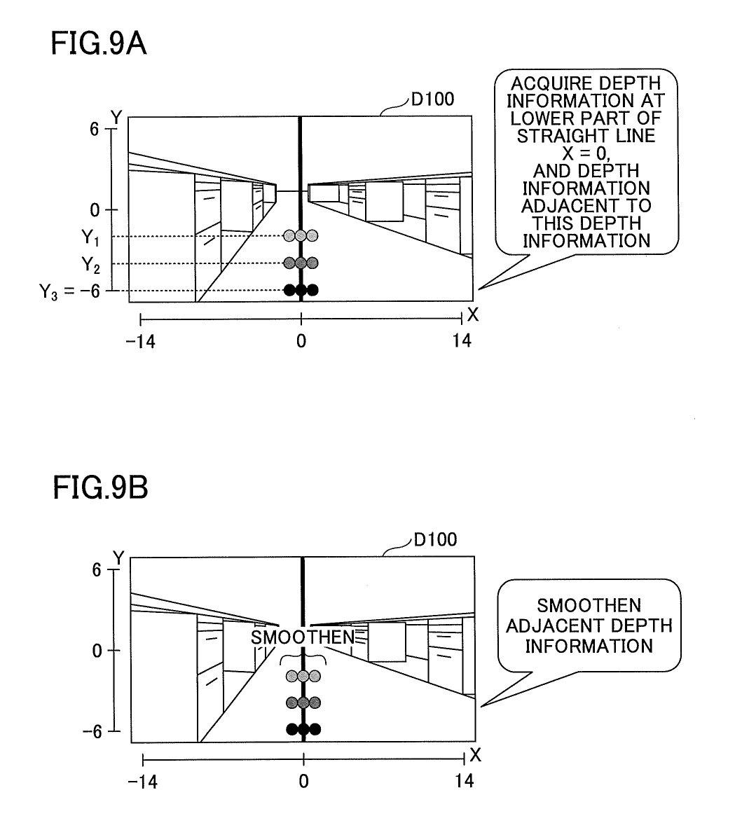

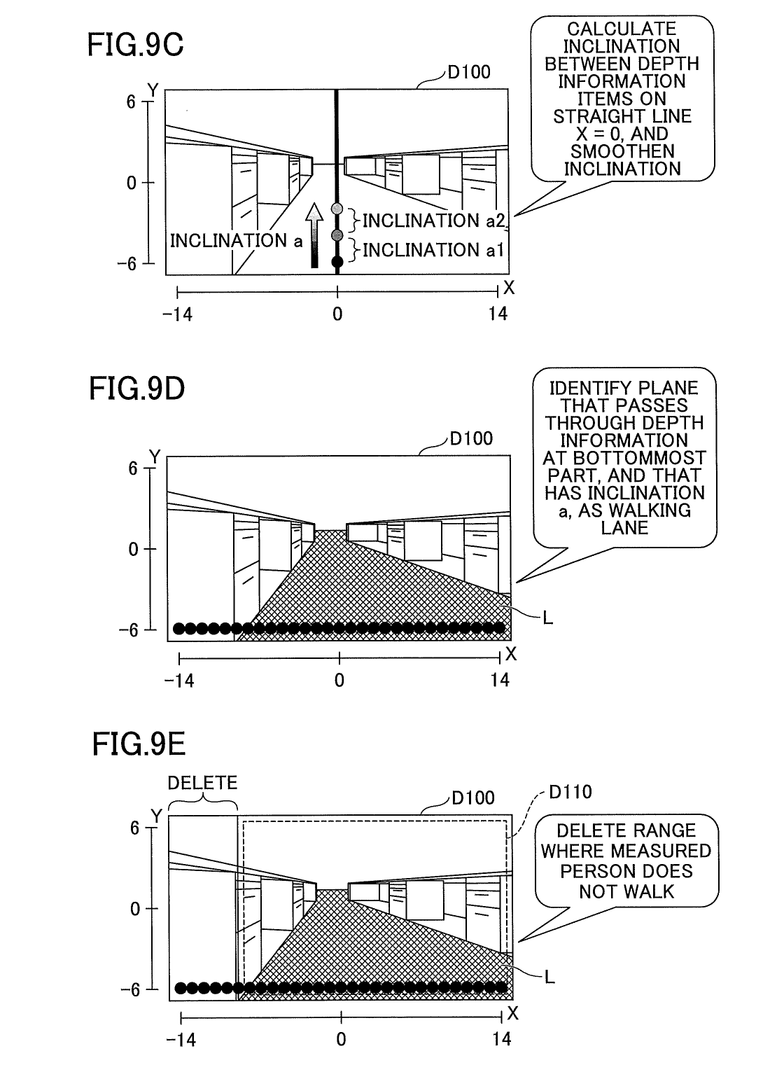

Here, an example of creation of walking range data will be described with reference to FIGS. 9A to 9E. FIGS. 9A to 9E are diagrams for explaining an example of creation of walking range data.

First, as illustrated in FIG. 9A, the walking range data creating unit 131 acquires depth information at the lower part of a straight line X=0 in the background data D100 (for example, a range of the lower one-third of the straight line X=0), and depth information adjacent to this depth information. Note that the adjacent depth information means the depth information at the position obtained by adding one (+1) to the value of the X coordinate of the depth information on the straight line X=0, and depth information at the position obtained by subtracting one (−1) from the value of the X coordinate of the depth information on the straight line X=0.

Hereinafter, it is assumed that the walking range data creating unit 131 acquires the depth information Z₀₁ at the coordinates (0, Y₁) in the background data D100, and the depth information Z₁₁ and Z₂₁ adjacent to the depth information Z₀₁. Similarly, it is assumed that the walking range data creating unit 131 acquires the depth information Z₀₂ at the coordinates (0, Y₂), the depth information Z₁₂ and Z₂₂ adjacent to the depth information Z₀₂, the depth information Z₀₃ at the coordinates (0, Y₃=−6), and the depth information Z₁₃ and Z₂₃ adjacent to the depth information Z₀₃.

Next, as illustrated in FIG. 9B, the walking range data creating unit 131 smoothens the depth information on the straight line X=0 and the depth information adjacent to this depth information on the straight line X=0. That is, the walking range data creating unit 131 calculates Zₐ=(Z₀₁+Z₁₁+Z₂₁)/3, in which Zₐ is the depth information at the coordinates (0, Y₁) in the background data D100. Similarly, the walking range data creating unit 131 calculates Z_{b}=(Z₀₂+Z₁₂+Z₂₂)/3, in which Z_{b} is the depth information at the coordinates (0, Y₂) in the background data D100. Furthermore, similarly, the walking range data creating unit 131 calculates Z_{c}=(Z₀₃+Z₁₃+Z₂₃)/3, in which Z_{c} is the depth information at the coordinates (0, Y₃) in the background data D100.

Next, as illustrated in FIG. 9C, the walking range data creating unit 131 calculates the inclination between the depth information items on the straight line X=0, and smoothens the inclination. That is, the walking range data creating unit 131 calculates a1=((Y₂−Y₃)/(Z_{b}−Z_{c})), in which a1 is the inclination between the depth information items Z_{c} and Z_{b}. Similarly, the walking range data creating unit 131 calculates a2=((Y₁−Y₂)/(Zₐ−Z_{b})), in which a2 is the inclination between the depth information items Z_{b} and Zₐ. Then, the walking range data creating unit 131 calculates the average value of the inclinations a1 and a2, as the inclination a after smoothing.

Next, as illustrated in FIG. 9D, the walking range data creating unit 131 identifies, as the walking lane L on which the measured person walks, a plane that passes through the coordinates of the depth information at the bottommost part of the background data D100 (that is, the coordinates (X, −6), −14≤X≤14), and that has an inclination a.

Next, as illustrated in FIG. 9E, the walking range data creating unit 131 deletes the range in which the measured person does not perform the walking motion (that is, the range that is not on the walking lane L), thereby creating walking range data D110. In other words, the walking range data creating unit 131 creates the walking range data D110 by trimming the range on the walking lane L from the background data D100. Accordingly, the walking range data D110 including the walking lane L is created.

Referring back to FIG. 8, after step S801, the data managing unit 107 acquires one piece of measurement data from the temporary storage unit 120 (step S802).

Next, the three-dimensional motion data creating unit 132 trims, from the measurement data acquired by the data managing unit 107, a range where the X coordinates and the Y coordinates are the same as those of the walking range data created by the walking range data creating unit 131 (step S803).

That is, for example, it is assumed that the ranges of the X coordinates and the Y coordinates of the measurement data are −14≤X≤14 and −6≤Y≤6, respectively, and the range of the X coordinates and the Y coordinates in the walking range data are −8≤X≤14 and −6≤Y≤6, respectively. In this case, the three-dimensional motion data creating unit 132 performs trimming by deleting the range where the X coordinates and the Y coordinates in the measurement data are −14≤X≤−9 and respectively.

Next, the three-dimensional motion data creating unit 132 identifies a point group indicating the measured person, from the trimmed measurement data and the walking range data, to create three-dimensional motion data (step S804).

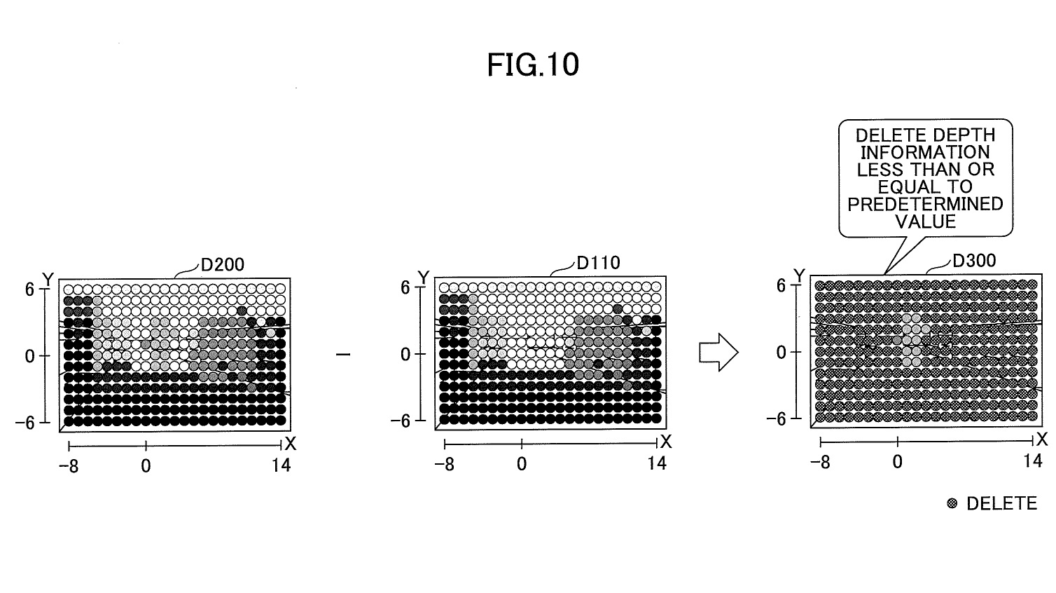

Here, an example of creation of three-dimensional motion data will be described with reference to FIG. 10. FIG. 10 is a diagram for describing an example of creation of three-dimensional motion data.

As illustrated in FIG. 10, the three-dimensional motion data creating unit 132 subtracts the depth information at the coordinates in the walking range data D110 from the depth information at coordinates in trimmed measurement data D200. Then, the three-dimensional motion data creating unit 132 deletes the depth information at the coordinates whose subtraction result is less than or equal to a predetermined threshold value, from the measurement data D200, to create three-dimensional motion data D300. Accordingly, the three-dimensional motion data creating unit 132 can create three-dimensional motion data D300 that is a point group indicating the measured person, for each inverse number of the frame rate of the depth sensor 42.

Referring back to FIG. 8, the data managing unit 107 determines whether next measurement data is stored in the temporary storage unit 120 (step S805). That is, the data managing unit 107 determines whether measurement data that has not yet been acquired, is stored in the temporary storage unit 120.

In step S805, when the data managing unit 107 determines that next measurement data is stored in the temporary storage unit 120, the data managing unit 107 acquires the next measurement data from the temporary storage unit 120 (step S806). Then, the motion-measurement-information data creation processing unit 105 executes the processes from step S803 and onward. Accordingly, three-dimensional motion data is created for each measurement data.

Conversely, in step S805, when the data managing unit 107 determines that next measurement data is not stored in the temporary storage unit 120, the motion information data creating unit 133 calculates motion information such as the number of steps, the stride length, the walking speed, and the foot lifting angle, etc. Then, the motion information data creating unit 133 creates motion information data indicating the calculated motion information (step S807).

Here, the number of steps is calculated, for example, from the three-dimensional motion data and the walking range data. That is, the motion information data creating unit 133 calculates the number of steps by counting the number of times the three-dimensional motion data touches the walking lane included in the walking range data. Note that the three-dimensional motion data touching the walking lane means, for example, that in the XYZ space, one or more points included in the walking lane are included near at least one point included in the three-dimensional motion data (that is, within a predetermined range from the point).

Furthermore, the stride length is calculated from, for example, the three-dimensional motion data and the walking range data. That is, when calculating the number of steps described above, the motion information data creating unit 133 obtains the difference between points where the three-dimensional motion data and the walking lane are in contact (for example, when the measured person walks toward the measuring device 40, the difference between the Z coordinates (depth information) of the points), to calculate the stride length.

Furthermore, the walking speed is calculated from, for example, the frame rate of the depth sensor 42 and the walking data. That is, the motion information data creating unit 133 obtains the transition per unit time of coordinates of a point included in three-dimensional motion data between frames (for example, when the measured person walks toward the measuring device 40, the transition per unit time of the Z coordinate of the point), to calculate the walking speed.

Furthermore, the foot lifting angle is calculated from the three-dimensional motion data, for example. That is, the motion information data creating unit 133 obtains the coordinates of a plurality of points in the YZ plane corresponding to the lower limbs of the measured person, among a plurality of points included in the three-dimensional motion data, to calculate the foot lifting angle.

Next, the motion-measurement-information data creating unit 134 creates motion-measurement-information data including the three-dimensional motion data created by the three-dimensional motion data creating unit 132 and motion information data created by the motion information data creating unit 133 (step S808).

Accordingly, the motion-measurement-information data creating unit 134 creates motion-measurement-information data including a plurality of pieces of three-dimensional motion data and motion information data for each inverse number of the frame rate of the depth sensor 42.

Since each piece of three-dimensional motion data is expressed by an assembly of points (point group) in the XYZ space, editing can be easily performed. For example, three-dimensional motion data whose Z coordinate value satisfies a predetermined condition can be acquired from a plurality of pieces of three-dimensional motion data. Thus, for example, it is possible to acquire only the three-dimensional motion data of the measured person, corresponding to where walking distance is between 3 m and 6 m, from among a plurality of pieces of three-dimensional motion data. Therefore, for example, the evaluator can confirm only the walking motion within the walking distance of 3 m to 6 m, which is a range in which the walking motion of the measured person is stable.

«Process from Operation for Displaying Measurement Result to Displaying Measurement Result»

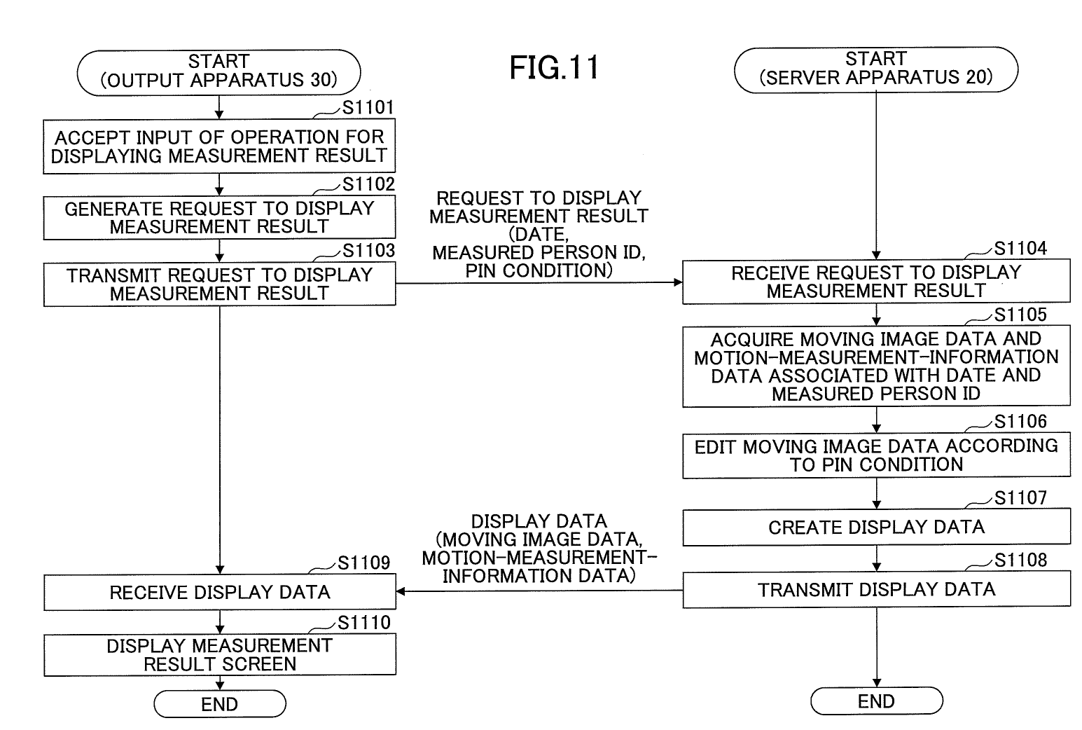

Next, with reference to FIG. 11, a description will be given of a process in which, for example, an evaluator, etc., performs an operation for displaying the measurement result to display the measurement result. FIG. 11 is a flowchart of an example of a process from the operation for displaying the measurement result to the display of the measurement result.

First, the input accepting unit 301 of the output apparatus 30 accepts an input of an operation for displaying the measurement result (step S1101). The measurement result display operation may be performed by either the evaluator or the measured person.

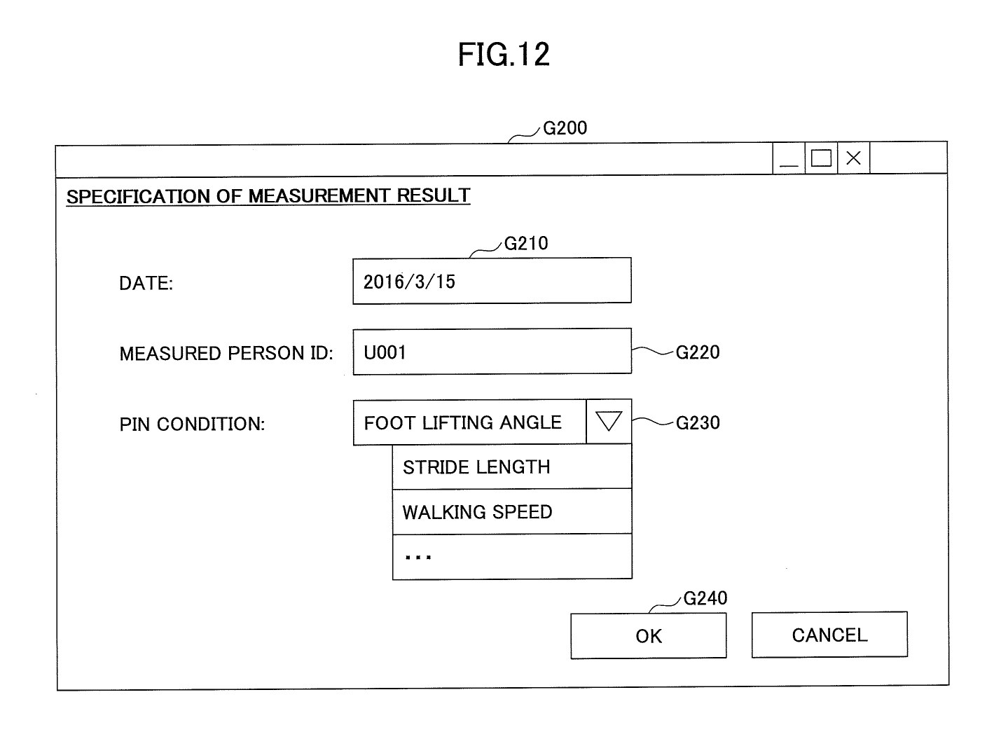

Here, the user (the evaluator or the measured person) of the output apparatus 30 can perform the measurement result display operation on a measurement result specification screen G200 illustrated in FIG. 12, displayed by the display control unit 302.

The measurement result specification screen G200 illustrated in FIG. 12 includes a date specification field G210, a measured person ID specification field G220, a pin condition specification field G230, and an OK button G240.

The user specifies a desired date on which the motion of the measured person has been measured, in the date specification field G210, and specifies the measured person ID for identifying the measured person, in the measured person ID specification field G220. Furthermore, the user selects (specifies) the condition of the pin to be added to the moving image, from the pin condition specification field G230.

By specifying a condition of a pin to be added to the moving image from the pin condition specification field G230, the user can add a pin at a position corresponding to the condition. Note that the user may specify conditions of a plurality of pins from the pin condition specification field G230.

For example, when “foot lifting angle” is selected from the pin condition specification field G230, a pin can be added to the position where the angle of the foot of the measured person has been minimum (or maximum) (that is, the playback time at which the angle of the foot of the measured person has been minimum (or maximum)). Furthermore, for example, when “stride length” is selected from the pin condition specification field G230, a pin can be added to the position at which the stride length of the measured person has been minimum (or the position at which the stride length of the measured person has been maximum, or the position at which the stride length of the measured person has been less than or equal to a predetermined threshold). Similarly, for example, when “walking speed” is selected from the pin condition specification field G230, a pin can be added to the position at which the walking speed of the measured person has been minimum (or the position at which the walking speed of the measured person has been maximum or the position at which the walking speed of the measured person has been less than or equal to a predetermined threshold).

Then, on the measurement result specification screen G200 illustrated in FIG. 12, the user presses the OK button G240. Accordingly, the operation for displaying the measurement result is performed.

Referring back to FIG. 11, after step S1101, when input of a measurement result display operation is accepted by the input accepting unit 301, the display requesting unit 304 of the output apparatus 30 creates a request to display the measurement result (step S1102). The measurement result display request includes the date, the measured person ID, and the pin condition specified in the measurement result specification screen G200 illustrated in FIG. 12.

Next, the communication unit 303 of the output apparatus 30 transmits the measurement result display request created by the display requesting unit 304, to the server apparatus 20 (step S1103).

The communication unit 201 of the server apparatus 20 receives the measurement result display request from the output apparatus 30 (step S1104).

Next, upon receiving the measurement result display request by the communication unit 201, the data managing unit 202 of the server apparatus 20 acquires the moving image data associated with the date and the measured person ID included in the display request, from the moving image data storage unit 210. Furthermore, the data managing unit 202 acquires the motion-measurement-information data associated with the date and the measured person ID from the motion-measurement-information data storage unit 220 (step S1105).

Next, the moving image data editing unit 203 of the server apparatus 20 edits the moving image data acquired by the data managing unit 202 according to the pin condition included in the measurement result display request received by the communication unit 201 (step S1106). That is, the moving image data editing unit 203 adds a pin to the moving image data based on the motion information data included in the motion-measurement-information data and the pin condition acquired by the data managing unit 202.

For example, when the pin condition is “foot lifting angle”, the moving image data editing unit 203 identifies the measurement time at which the angle of the foot of the measured person has become minimum (or maximum, etc.) from the motion information data. Then, the moving image data editing unit 203 adds a pin to the position of the replay time (replay time of the moving image data) corresponding to the identified measurement time.

Furthermore, for example, when the pin condition is “stride length”, the moving image data editing unit 203 identifies the measurement time at which the stride length of the measured person has become minimum (or maximum, etc.) from the motion information data. Then, the moving image data editing unit 203 adds a pin to the position of the replay time corresponding to the identified measurement time.

Similarly, for example, when the pin condition is “walking speed”, the moving image data editing unit 203 identifies the measurement time at which the walking speed of the measured person has become minimum (or maximum, etc.) from the motion information data. Then, the moving image data editing unit 203 adds a pin to the position of the replay time corresponding to the identified measurement time.

Next, the display data creating unit 204 of the server apparatus 20 creates display data including the moving image data edited by the moving image data editing unit 203 and the motion-measurement-information data acquired by the data managing unit 202 (step S1107).

Next, the communication unit 201 of the server apparatus 20 transmits the display data created by the display data creating unit 204, to the output apparatus 30 (step S1108).

The communication unit 303 of the output apparatus 30 receives the display data from the server apparatus 20 (step S1109).

Next, when the display data is received by the communication unit 303, the display control unit 302 of the output apparatus 30 displays a measurement result screen indicating the measurement result of the walking motion of the measured person, based on the display data (step S1110).

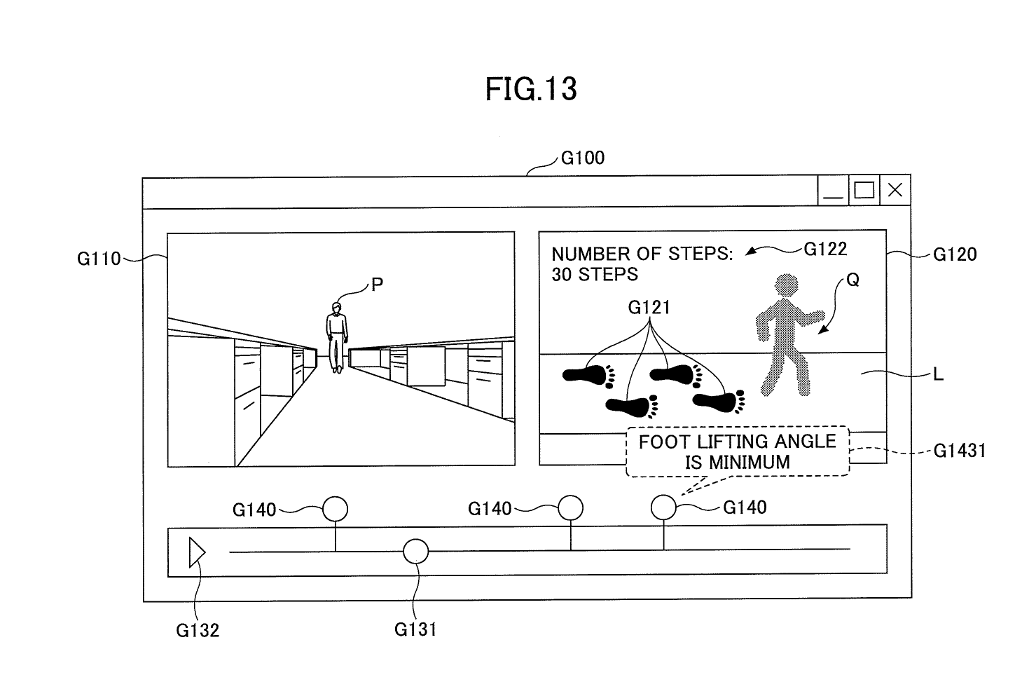

Here, an example of the measurement result screen indicating the measurement result of the walking motion of the measured person will be described with reference to FIG. 13. FIG. 13 is a diagram illustrating an example of the measurement result screen G100.

The measurement result screen G100 illustrated in FIG. 13 includes the moving image display field G110 for displaying a moving image of the motion of the measured person P, and the three-dimensional display field G120 for displaying a point group Q expressing the motion of the measured person P displayed in the moving image display field G110 as a three-dimensional point group. Here, since the point group Q displayed in the three-dimensional display field G120 is an assembly of points in the XYZ space, the point group Q can be displayed from various directions according to operations by the evaluator, for example. Therefore, by confirming the motion of the point group Q from various directions, for example, the evaluator can confirm the motion of the measured person P from various directions.

The three-dimensional display field G120 includes the walking lane L, the footprints G121 on the walking lane L created during the walking motion of the measured person P, and a number of steps G122 in the walking motion of the measured person P. Thus, for example, the evaluator can confirm the stride length and number of steps during the walking motion of the measured person P. In the three-dimensional display field G120, the walking speed and the foot lifting angle in the walking motion of the measured person P may be displayed.

Furthermore, the measurement result screen G100 illustrated in FIG. 13 includes a seek bar G131, a play/stop button G132, and a pin G140. The user may operate the seek bar G131 to display a moving image at any replay time in the moving image display field G110 and display the point group Q, etc., at the measurement time corresponding to the replay time in the three-dimensional display field G120.

Furthermore, by pressing the play/stop button G132, the user can play and pause the moving image displayed in the moving image display field G110 and the point group Q, etc., displayed in the three-dimensional display field G120.

Furthermore, by pressing the pin G140, the user can display the moving image at the replay time corresponding to the pressed pin G140 in the moving image display field G110, and display the point group Q, etc., at the measurement time corresponding to the replay time in the three-dimensional display field G120. Note that the user can display an explanation G1431 of the position indicated by the pin G140 by, for example, superimposing a mouse cursor, etc., on the pin G140.

In this way, in the measurement result screen G100, the user can confirm the motion of the measured person P by a moving image, and confirm the motion as the movement of the three-dimensional point group Q. Furthermore, by pressing the pin G140, the user can easily display the time point when the foot lifting angle has become minimum and the time point when the stride length has become minimum, etc., during the motion. Accordingly, the user can easily evaluate the motion, etc., of the measured person P.

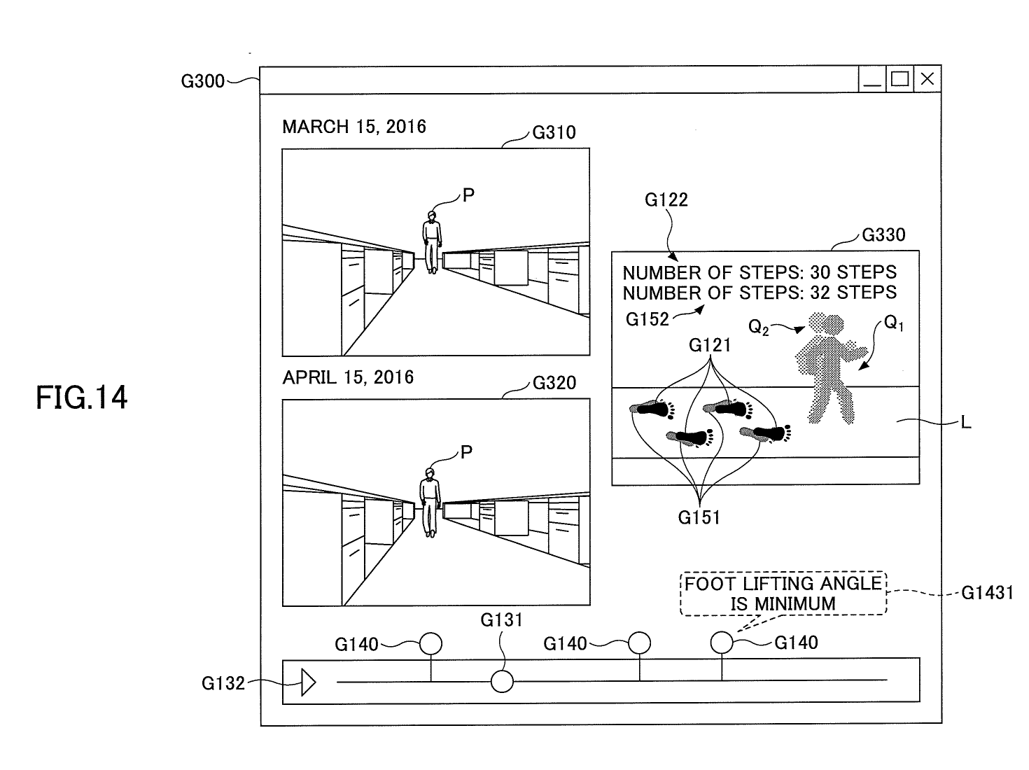

Here, another example of the measurement result screen indicating the measurement result of the walking motion of the measured person will be described with reference to FIG. 14. FIG. 14 is a diagram illustrating another example of a measurement result screen G300.

The measurement result screen G300 illustrated in FIG. 14 is a screen displayed when a plurality of dates are specified in the date specification field G210 in the measurement result specification screen G200 illustrated in FIG. 12, for example.

The measurement result screen G300 illustrated in FIG. 14 includes a moving image display field G310 for displaying a moving image obtained by capturing the motion of the measured person P on the date “Mar. 15, 2016” specified in the date specification field G210. Furthermore, the measurement result screen G300 illustrated in FIG. 14 includes a moving image display field G320 for displaying a moving image obtained by capturing the motion of the measured person P on the date “Apr. 15, 2016” specified in the date specification field G210.

Furthermore, the measurement result screen G300 illustrated in FIG. 14 includes a three-dimensional display field G330 for displaying a point group Q₁ and a point group Q₂ in which the motions of the measured person P displayed in the moving image display field G310 and the moving image display field G320, are respectively expressed by three-dimensional point groups. That is, the three-dimensional display field G330 includes the point group Q₁ expressing the motion of the measured person P on the date “Mar. 15, 2016” and the point group Q₂ expressing the motion of the measured person P on the date “Apr. 15, 2016” . . . .

Also, the three-dimensional display field G330 includes the footprints G121 of the measured person P on the date “Mar. 15, 2016” and footprints G151 of the measured person P on the date “Apr. 15, 2016”. Furthermore, the three-dimensional display field G330 includes the number of steps G122 in the walking motion of the measured person P on the date “Mar. 15, 2016” and a number of steps G152 in the walking motion of the measured person P on the date “Apr. 15, 2016”.

In this manner, in the measurement result screen G300, the user can confirm the motion of the measured person P on a plurality of dates with moving images, and confirm these motions as the movements of the three-dimensional point groups. Therefore, the user can perform the evaluation while comparing the motions of the measured person P on the plurality of dates.

As described above, in the motion measurement system 1 according to the present embodiment, a moving image obtained by capturing the motion of the measured person is displayed on the output apparatus 30 and a three-dimensional point group expressing the motion is displayed on the output apparatus 30. Here, in the motion measurement system 1 according to the present embodiment, the stride length and the number of steps, etc. of the measured person are displayed.

Accordingly, the evaluator can provide guidance for improvement of the motion and the posture, etc., of the measured person by referring to the measurement result screen. Also, similarly, the measured person can improve his/her motion and posture, etc., by referring to the measurement result screen.

According to one embodiment of the present invention, evaluation of motions can be supported. According to one embodiment of the present invention, in addition to acquiring a moving image with an imaging device, information is acquired with a depth sensor, and three-dimensional motion data is acquired and stored based on the information acquired with the depth sensor. Thus, various kinds of information such as the stride length can be calculated and measured from the three-dimensional motion data, according to need. The motion measuring system according to an embodiment of the present invention is different from a system of the related art in which motion images need to be repeatedly captured.

The motion measuring system, the motion measuring apparatus, and the motion measuring method are not limited to the specific embodiments described in the detailed description, and variations and modifications may be made without departing from the spirit and scope of the present invention.

What is claimed is:

1. A motion measuring system for measuring a motion of a target person, the motion measuring system comprising a processor, in communication with a memory, executing a process including:
creating three-dimensional motion data expressing the motion with a three-dimensional point group, by measuring the motion of the target person with a depth sensor, the three-dimensional motion data being created based on motion range data expressing a range of the motion and measurement data created during the motion;
creating motion-measurement-information data including the created three-dimensional motion data and motion information data indicating one or more kinds of information relating to one or more aspects of the motion;
creating moving image data by imaging the motion of the target person; and
displaying, on a display device in response to an operation by a user evaluating the one or more aspects of the motion, the three-dimensional point group and the one or more kinds of information relating to the one or more aspects of the motion based on the created motion-measurement-information data, and a moving image based on the created moving image data obtained by a single imaging operation.

2. The motion measuring system according to claim 1, wherein the creating of the three-dimensional motion data includes:
calculating a difference between depth information included in the measurement data created by measuring the motion with the depth sensor, and depth information included in background data created in advance by the depth sensor; and
creating the three-dimensional motion data by deleting, from the depth information included in measurement data, depth information for which the difference is less than or equal to a predetermined value.

3. The motion measuring system according to claim 1, wherein the process further includes:
editing the moving image by setting a pin at a position corresponding to a predetermined replay time in the moving image, based on the created moving image data and the motion information data, wherein
the displaying further includes displaying a display component indicating the pin for replaying the moving image from the predetermined replay time.

4. The motion measuring system according to claim 3, wherein the editing of the moving image includes setting the pin at the position corresponding to the predetermined replay time at which the one or more kinds of information indicated by the motion information data satisfy a predetermined condition, based on the moving image data and the motion information data.

5. The motion measuring system according to claim 1, wherein
the motion includes a walking motion, and
the motion-measurement-information data includes the three-dimensional motion data and the motion information data indicating at least one of a stride length, a number of steps, a walking speed, and a foot lifting angle while walking, in the walking motion.

6. A motion measuring apparatus for measuring a motion of a target person, the motion measuring apparatus comprising a processor, in communication with a memory, executing a process including:
creating three-dimensional motion data expressing the motion with a three-dimensional point group, by measuring the motion of the target person with a depth sensor, the three-dimensional motion data being created based on motion range data expressing a range of the motion and measurement data created during the motion;
creating motion-measurement-information data including the created three-dimensional motion data and motion information data indicating one or more kinds of information relating to one or more aspects of the motion;
creating moving image data by imaging the motion of the target person; and
displaying, on a display device connected to the motion measuring apparatus in response to an operation by a user evaluating the one or more aspects of the motion, the three-dimensional point group and the one or more kinds of information relating to the one or more aspects of the motion based on the created motion-measurement-information data, and a moving image based on the created moving image data obtained by a single imaging operation.

7. A motion measuring method executed by a computer in a motion measuring system for measuring a motion of a target person, the motion measuring method comprising:
creating three-dimensional motion data expressing the motion with a three-dimensional point group, by measuring the motion of the target person with a depth sensor, the three-dimensional motion data being created based on motion range data expressing a range of the motion and measurement data created during the motion;
creating motion-measurement-information data including the created three-dimensional motion data and motion information data indicating one or more kinds of information relating to one or more aspects of the motion;
creating moving image data by imaging the motion of the target person; and
displaying, on a display device in response to an operation by a user evaluating the one or more aspects of the motion, the three-dimensional point group and the one or more kinds of information relating to the one or more aspects of the motion based on the created motion-measurement-information data, and a moving image based on the created moving image data obtained by a single imaging operation.
